(19) United States
(12) Patent Application Publication
(10) Pub. No.: US 2026/0109609 A1
(43) Pub. Date: Apr. 23, 2026

(54) METHOD OF PRODUCING ACTIVATED CARBON AND SILICA AND RECYCLING RESOURCES

(71) Applicants: Hyundai Motor Company, Seoul (KR); Kia Corporation, Seoul (KR); INSTITUTE FOR ADVANCED ENGINEERING, Yongin-si (KR)

(72) Inventors: Kwang Mo SEONG, Hwaseong-si (KR); Jung Eun PARK, Yongin-si (KR); Geon Woong HYEON, Yongin-si (KR); Gi Boum LEE, Yongin-si (KR); Eun Hye SONG, Ulsan (KR); Sang Eun LEE, Cheonan-si (KR); Gyeong Woo KIM, Yongin-si (KR)

(21) Appl. No.: 19/022,623

(22) Filed: Jan. 15, 2025

(30) Foreign Application Priority Data
Oct. 23, 2024 (KR) 10-2024-0145508

(51) Int. Cl. C01B 32/324; B01J 39/18; C01B 32/336; C01B 32/348; C01B 32/39; C01B 33/18

(52) U.S. Cl. CPC C01B 32/324; B01J 39/18; C01B 32/336; C01B 32/348; C01B 32/39; C01B 33/18; C01P 2006/80

(57) ABSTRACT

A method for producing activated carbon and silica and recycling resources includes producing the activated carbon by at least performing a first carbonization heat-treatment on a carbon precursor, treating the heat-treated carbon precursor with an activating agent that includes a first alkali metal salt to produce a first mixture, and washing and drying the first mixture to obtain the activated carbon and waste liquid. The method further includes producing the silica by at least performing a second carbonization heat-treatment on a biomass-derived raw material that includes the silica, treating the biomass-derived raw material with a second alkaline solution to produce a second mixture and separating residues to obtain a filtrate, neutralizing the filtrate and performing a solid-liquid separation on the neutralized filtrate, performing an ion-exchange between the waste liquid and preliminary alkaline solution, and using the ion-exchanged waste liquid toward the activating agent using the ion-exchanged preliminary alkaline solution toward the second alkaline solution.

### CROSS-REFERENCE TO RELATED APPLICATION

This application claims priority to and the benefit of Korean Patent Application No. 10-2024-0145508, filed on Oct. 23, 2024, the disclosure of which is incorporated herein by reference in its entirety.

### TECHNICAL FIELD

The present disclosure relates to a method of producing activated carbon and silica and of recycling resources.

### BACKGROUND

Organic waste may be processed through methods such as landfilling or ocean dumping, and may be converted into compost, feed, and the like through aerobic processes. However, due to the lack of landfill sites and the possibility of secondary pollution sources flowing into the water system, negative perceptions about landfilling organic waste are widespread, and ocean dumping, which was a representative processing method, was banned by the London Convention.

Anaerobic digestion, which is a method of processing organic waste, may be used due to more advantages over aerobic processes, and may be developed into an eco-friendly resource regeneration method of producing fuel and compost in addition to simple decomposition of organic waste.

In some examples, various inorganic substances and silica may exist in substances called “biomass,” and lignocellulosic biomass such as rice husk and rice straw is known to have silica of about 10 to about 20 wt %. Biomass resources may contain cellulose, hemicellulose, and lignin, and may contain inorganic substances and other substances.

### SUMMARY

Implementations according to this disclosure includes a method of producing activated carbon with a high surface area using organic waste and producing high-purity silica using biomass-derived raw materials while efficiently recycling resources.

In some implementations, the present disclosure provides a method of producing activated carbon and silica, and of recycling resources, the method including producing activated carbon including (a-1) carbonization heat-treating a carbon precursor, (a-2) treating the result obtained from step (a-1) with an activator containing a first alkali metal salt, and (a-3) washing and drying the result obtained from step (a-2), producing silica including (b-1) carbonization heat-treating a silica-containing biomass-derived raw material, (b-2) treating the result of step (b-1) with a second alkaline solution, separating residues, and obtaining a filtrate, and (b-3) neutralizing the filtrate, followed by solid-liquid separation, (c-1) ion-exchanging at least a part of the waste liquid obtained after washing of step (a-3) with a preliminary alkaline solution through an ion exchange resin, and (c-2) applying the ion-exchanged waste liquid after washing as an activator of step (a-2) and applying the ion-exchanged preliminary alkaline solution as a second alkaline solution of step (b-2).

In some implementations, the present disclosure provides an ion exchange method during production of activated carbon and silica, the method including (1) activated carbon preparation including washing a carbon-based material treated with an activator containing a first alkali metal salt, (2) silica preparation including treating a carbonization heat-treated silica-containing biomass-derived material with a second alkaline solution, (3-1) ion-exchanging at least a part of the waste liquid obtained after the washing in step (1) with a preliminary alkaline solution through an ion exchange resin, and (3-2) applying each of the materials ion-exchanged in step (3-1) to the activator in step (1) or the second alkaline solution in step (2).

In some implementations, the present disclosure provides a device configured to produce activated carbon and silica, and to recycle resources, the device including an activator producer, the activator producer including a first heat treatment unit configured to heat-treat a carbon precursor, an activation unit configured to treat the result heat-treated by the first heat treatment unit with an activator containing a first alkali metal salt, and a washing unit configured to wash and dry the result treated with the activator by the activation unit, a silica producer, the silica producer including a second heat treatment unit configured to heat-treat a silica-containing biomass-derived raw material, a dissolution unit configured to treat the result heat-treated by the second heat treatment unit with an alkaline solution and to obtain a residue-separated filtrate, and a separation unit configured to neutralize the filtrate obtained by the dissolution unit and to perform solid-solution separation; and an ion exchange unit configured to exchange at least a part of the waste liquid produced by the washing unit with ions of the preliminary alkaline solution, wherein the waste liquid ion-exchanged by the ion exchange unit is applied to the activation unit and the preliminary alkaline solution ion-exchanged by the ion exchange unit is applied to the dissolution unit.

Other aspects and implementations of the disclosure are discussed infra.

### BRIEF DESCRIPTION OF THE DRAWINGS

FIG. 1 is a flowchart illustrating an example of producing activated carbon and silica while recycling resources.

FIG. 2 is a graph illustrating an example of the silica purity obtained based on the type and concentration of an alkali metal salt of a second alkaline solution in Experimental Example 1.

FIG. 3 is a graph illustrating an example of an ion exchange efficiency based on the concentration of waste liquid during repeated ion exchange in Experimental Example 2.

FIG. 4 is a graph illustrating an example of an ion exchange efficiency based on the concentration of preliminary alkaline solution during repeated ion exchange in Experimental Example 3.

FIG. 5 is a schematic diagram illustrating an example of a device for producing activated carbon and silica while recycling resources.

### DETAILED DESCRIPTION

The objects described above, as well as other objects, features and advantages, will be clearly understood from the following preferred implementations with reference to the attached drawings. However, the present disclosure is not limited to the implementations and can be implemented in different forms. The implementations are suggested only to offer a thorough and complete understanding of the disclosure and to sufficiently inform those skilled in the art of the technical concept of the present disclosure.

Unless the context clearly indicates otherwise, all numbers, figures and/or expressions that represent ingredients, reaction conditions, polymer compositions and amounts of mixtures used in the specification are approximations that reflect various uncertainties of measurement occurring inherently in obtaining these figures, among other things. For this reason, it should be understood that, in all cases, the term “about” should be understood to modify all numbers, figures and/or expressions. In addition, when numerical ranges are disclosed in the description, these ranges are continuous, and include all numbers from the minimum to the maximum, including the maximum within each range, unless defined otherwise. Furthermore, when the range refers to an integer, it includes all integers from the minimum to the maximum, including the maximum within the range, unless defined otherwise.

Method of Producing Activated Carbon and Silica while Recycling Resources

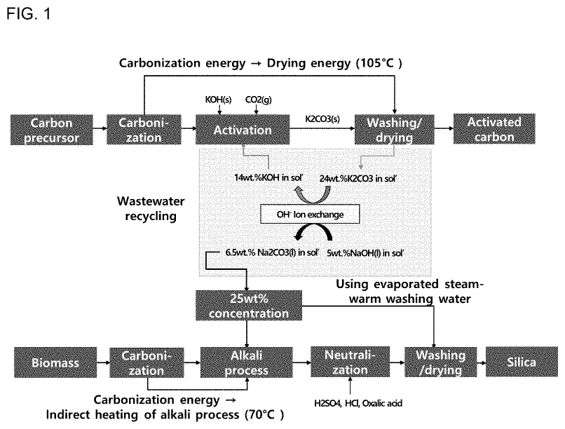

Referring to FIG. 1, the method of producing activated carbon and silica while recycling resources according to the present disclosure includes:
activated carbon production including:
(a-1) carbonization heat-treating a carbon precursor;
(a-2) treating the result obtained from step (a-1) with an activator containing a first alkali metal salt; and
(a-3) washing and drying the result obtained from step (a-2);
silica production including:
(b-1) carbonization heat-treating a silica-containing biomass-derived raw material;
(b-2) treating the result of step (b-1) with a second alkaline solution, separating residues and obtaining a filtrate; and
(b-3) neutralizing the filtrate, followed by solid-liquid separation;
(c-1) ion-exchanging at least a part of the waste liquid obtained after washing of step (a-3) with a preliminary alkaline solution through an ion exchange resin; and
(c-2) applying the ion-exchanged washed waste liquid as an activator of step (a-2) and applying the ion-exchanged preliminary alkaline solution as a second alkaline solution of step (b-2).

Steps (a-1) to (a-3) are steps for producing activated carbon from a carbon precursor, and steps (b-1) to (b-3) are steps for producing silica from a silica-containing biomass-derived raw material. Steps (c-1) and (c-2) are steps for ion-exchanging the waste liquid produced during the production of activated carbon and the alkaline solution applicable during the production of silica through an ion exchange resin, and applying each of the ion-exchanged materials to steps (a-2) and (b-2).

In some examples, the carbon precursor obtained from step (a-1) can contain an organic waste resource and the organic waste resource can include at least one selected from the group consisting of agricultural by-products, wood by-products, waste paper, natural fiber waste, coffee grounds, and combinations thereof. The carbon precursor can be used without limitation as long as it is a carbon-based material useful as a raw material for activated carbon. The carbon precursor can be the same as the biomass-derived raw material of step (b-1).

In some implementations, the carbonization heat-treatment of step (a-1) can be performed at a temperature of 300° C. to 900° C. in an inert gas (non-reactive gas) atmosphere for 0.5 to 10 hours. The inert gas can include nitrogen, helium, argon, neon, or a mixture thereof.

In step (a-2), in addition to the first alkali metal salt, carbon dioxide gas can be further incorporated. The first alkali metal can include an alkali metal or an alkaline earth metal, and can be selected from the group consisting of sodium, potassium, magnesium, calcium, strontium, barium, and combinations thereof, and preferably, sodium, potassium, or the like.

The first alkali metal salt of step (a-2) can include first alkali metal hydroxide, first alkali metal carbonate, or the like, can include potassium hydroxide, sodium hydroxide, magnesium hydroxide, calcium hydroxide, potassium carbonate, sodium carbonate, magnesium carbonate, calcium carbonate, or the like, and preferably can include potassium hydroxide or sodium hydroxide.

The step (a-2) can include mixing and heat-treating the result of step (a-1) with the activator. In some implementations, the heat treatment of step (a-2) can be performed at a temperature of 500° C. to 1,000° C. in an inert gas atmosphere optionally containing carbon dioxide for 0.5 to 6 hours. The inert gas can include nitrogen, helium, argon, neon, or a mixture thereof.

The first alkali metal salt of step (a-2) can be in a powder form or a solution form, and the solution can be applied to or coated on the result of step (a-1). In some examples, step (a-2) can be performed such that the weight ratio of the result of step (a-1) to the first alkali metal hydroxide is set to 1:0.5 to 1:5. In this case, the activation treatment can be performed effectively while minimizing waste of resources.

The washing of step (a-3) can be performed using water and the waste liquid after the washing can contain the first alkali metal cation and carbonate anion. Washing can be performed such that the alkali metal salt concentration of the waste liquid after washing is 10 wt % to 30 wt %. In addition, the alkali metal salt concentration of the waste liquid after the washing can be 18 wt % to 26 wt %. In this case, the optimal ion exchange efficiency can be obtained in the subsequent step (c-1).

The washing of step (a-3) can be performed repeatedly and at this time, the total waste liquid containing all the washing waste liquids can satisfy the alkali metal salt concentration.

In the drying of step (a-3), the waste heat can be applied during the carbonization heat-treatment of step (a-1). The waste heat can be transferred through a heat transfer means such as a separate air inlet, a flow path, an exhaust outlet-communicated means, a heat conductor, or the like using gas as a medium.

In some implementations, the temperature during drying of step (a-3) can be 50° C. to 120° C.

In some examples, the activated carbon formed by step (a-3) can have a BET (Brunauer-Emmett-Teller equation) specific surface area of 2,000 m²/g or more, 2,800 m²/g or more, and 3,500 m²/g or less.

Ine some examples, the biomass-derived raw material of step (b-1) can contain lignocellulosic biomass, and the lignocellulosic biomass is a complex containing cellulose, hemicellulose, lignin, inorganic substances, or the like. The lignocellulosic biomass can include at least one selected from the group consisting of rice husk, rice straw, rice bran, wheat straw, agricultural byproducts, and combinations thereof.

In some examples, the biomass-derived raw material of step (b-1) can contain silica in an amount of about 10 to 20 wt % based on the total weight of the raw material. The biomass-derived raw material of step (b-1) can have a moisture content of 20 wt % or less and 0.1 wt % or more.

The carbonization heat-treatment of step (b-1) can be the same as the temperature, time, and gas atmosphere of the carbonization heat-treatment of step (a-1) and a lower temperature can be used. For example, the temperature can be 300° C. to 700° C.

The second alkali solution of step (b-2) can include a solution of a material selected from the group consisting of second alkali metal hydroxide, second alkali metal carbonate, and combinations thereof. The second alkali metal can include an alkali metal or an alkaline earth metal, and can include at least one selected from the group consisting of sodium, potassium, magnesium, calcium, strontium, barium, and combinations thereof, and preferably, sodium, potassium, or the like. The second alkaline solution of step (b-2) can include a solution of potassium hydroxide, sodium hydroxide, magnesium hydroxide, calcium hydroxide, potassium carbonate, sodium carbonate, magnesium carbonate, calcium carbonate, or the like.

In some examples, the concentration of the second alkaline solution of step (b-2) can be 10 wt % to 30 wt %.

The concentration can correspond to a content of the second alkali metal salt (solute) based on 100 wt % of the total solution.

In some examples, step (b-2) can be performed at a temperature of 40° C. to 90° C. for 0.5 to 3 hours.

In some implementations, step (b-2) can be performed using residual heat or waste heat of the carbonization heat-treatment of step (b-1), and heating can be realized due to the temperature of the carbonized result in step (b-1) or waste heat transferred through a separate heat transfer means without a separate heating means.

After treatment with the second alkaline solution in step (b-2), a solid-liquid separation can be performed to obtain a filtrate and a residue.

The filtrate of step (b-2) can contain a silica component dissolved in the result of step (b-1). In addition, the residue can include a carbon-based material and can be treated with an activator in step (a-2).

The neutralization of step (b-3) can be performed using an acid solution selected from the group consisting of sulfuric acid, hydrochloric acid, nitric acid, acetic acid, perchloric acid, oxalic acid, and combinations thereof. The concentration of the acid solution can be 10 wt % to 30 wt %.

The neutralization of step (b-3) can be performed such that the weight ratio of the filtrate to acid solution is 1:0.5 to 1:4, and the acid solution can be added such that the pH of the filtrate is 6 to 8.

The solid-liquid separation of step (b-3) can be performed using a conventional filtration means or solid-liquid separator.

Among the secondary filtrate and the secondary residue obtained after solid-liquid separation in step (b-3), the secondary filtrate can be discarded and the secondary residue can be obtained.

The secondary residue obtained through step (b-3) can be subjected to washing and drying. In addition, heat treatment can be further performed after washing and drying. In some implementations, the heat treatment temperature of the secondary residue can be 500° C. to 1,000° C., and can be performed in an inert gas atmosphere for 0.5 to 6 hours. The inert gas can include nitrogen, helium, argon, neon, and a mixture thereof.

High-purity silica with a high specific surface area can be obtained through step (b-3).

In some examples, the silica produced through step (b-3) can have a BET (Brunauer-Emmett-Teller equation) specific surface area of 50 m²/g or more, 120 m²/g or more, and 300 m²/g or less.

In some implementations, the ion exchange resin of the step (c-1) can be in the form of a membrane having a predetermined thickness.

The concentration of the preliminary alkaline solution of step (c-1) can be 2 wt % to 30 wt %, 4 wt % to 10 wt %, or 5 wt % to 9 wt %. In this concentration range, an optimal ion exchange rate can be obtained.

The ion exchange resin of step (c-1) can be an anion exchange resin and can contain hydroxide ions electrostatically bonded (interacting) with a cation group. For example, the anion exchange resin can include polystyrene having an ammonium cation group (—NR₃⁺, each R is a methyl group or hydrogen) and a hydroxide ion (OH⁻) as a terminal group bonded thereto, and the cation group and the anion group can be easily substituted due to weak electrostatic interaction thereof and can correspond to a so-called “ion pair.”

Step (c-1) can be performed repeatedly. In some implementations, step (c-1) can be performed 1 to 20 times, or 2 to 15 times.

Step (c-1) can include:
(c-1-1) substituting bicarbonate ions derived from carbonate ions of the waste liquid after the washing with hydroxide ions of the ion exchange resin; and
(c-1-2) adding a preliminary alkali metal hydroxide solution to the ion exchange resin containing the substituted bicarbonate ions, substituting the bicarbonate ions with hydroxide ions, and regenerating a second alkaline solution containing bicarbonate ions and residual hydroxide ions.

The waste liquid having undergone step (c-1-1) can have a decreased bicarbonate ion concentration and an increased hydroxide ion concentration due to the substitution of bicarbonate ions, and thus a waste liquid containing a first alkali metal hydroxide having a predetermined concentration can be obtained.

The waste liquid having undergone step (c-1-1) can be used as an activator of step (a-2) and can be recycled. In some examples, the waste liquid having undergone step (c-1-1) can be optimally evaporated and concentrated to obtain a solid first alkali metal hydroxide.

The second alkaline solution having undergone step (c-1-2) can have a decreased hydroxide ion concentration and an increased bicarbonate ion concentration due to the substitution of hydroxide ions and can have an increased carbonate ion concentration due to the residual hydroxide ions and chemical equilibrium.

In some examples, the second alkaline solution having undergone step (c-1-2) can be further evaporated and concentrated to adjust the concentration to a predetermined level, and then can be used as the second alkaline solution of step (b-2). At this time, the evaporated vapor can be used to wash the secondary residue obtained in step (b-3).

The ion-exchanged waste liquid after washing of step (c-2) can contain anions of the preliminary alkaline solution, and the ion-exchanged preliminary alkaline solution can contain anions of the waste liquid after washing.

The ion-exchanged waste liquid after washing of step (c-2) can also be used as the second alkaline solution of step (b-2).

Step (a-1) or step (b-1) can be performed in any order.

Step (c-1-1) and step (c-1-2) can be performed alternately and the substitution-regeneration of the ion exchange resin can be repeatedly performed.

That is, the method of manufacturing activated carbon and silica while recycling resources according to one aspect of the present disclosure contributes to the formation of materials for production of silica from biomass-derived materials using materials produced as a waste liquid during the production of activated carbon, thereby increasing resource recyclability.

### Ion Exchange Method During Production of Activated Carbon and Silica

In addition, the ion exchange method during the production of activated carbon and silica according to one aspect of the present disclosure can include:
(1) activated carbon preparation including washing a carbon-based material treated with an activator containing a first alkali metal salt;
(2) silica preparation including treating a carbonization heat-treated silica-containing biomass-derived material with a second alkaline solution;
(3-1) ion-exchanging at least a part of the waste liquid obtained after the washing in step (1) with a preliminary alkaline solution through an ion exchange resin; and
(3-2) applying each of the materials ion-exchanged in step (3-1) to the activator in step (1) or the second alkaline solution in step (2).

Step (1) can include some or all of steps described in (a-1) to (a-3), and redundant descriptions of the activator treatment, washing, and waste liquid after the washing are omitted.

Step (2) can include some or all of steps described in (b-1) to (b-3), and redundant descriptions of carbonization heat treatment, second alkaline solution, subsequent processes, and the like are omitted.

Steps (3-1) and (3-2) can include some or all of steps described in (c-1) and (c-2) and redundant descriptions of ion exchange resin, ion exchange process, application of ion-exchanged materials, and the like are omitted.

### Device for Producing Activated Carbon and Silica, and for Recycling Resources

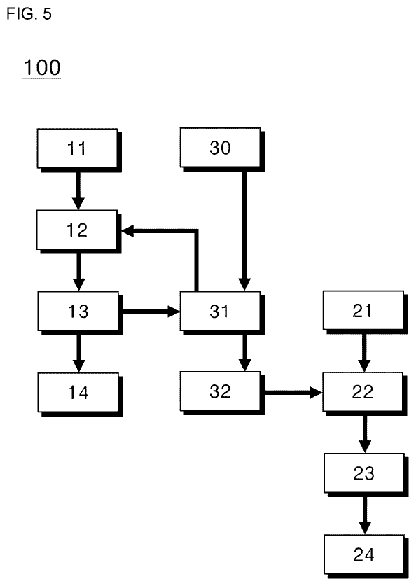

Referring to FIG. 5, the device for producing activated carbon and silica, and for recycling resources includes:
an activated carbon producer including:
a first heat treatment unit 11 configured to heat-treat a carbon precursor;
an activation unit 12 configured to treat the carbon precursor heat-treated by the first heat treatment unit 11 with an activator containing a first alkali metal salt; and
a washing unit 13 configured to wash and dry the carbon precursor treated with the activator by the activation unit 12;
a silica producer including:
a second heat treatment unit 21 configured to heat-treat a silica-containing biomass-derived raw material;
a dissolution unit 22 configured to treat the raw material heat-treated by the second heat treatment unit 21 with an alkaline solution and to obtain a residue-separated filtrate; and
a separation unit 23 configured to neutralize the filtrate obtained by the dissolution unit 22 and to perform solid-solution separation; and
an ion exchange unit 31 configured to exchange at least a part of the waste liquid produced by the washing unit 13 with ions of the preliminary alkaline solution,
wherein the waste liquid ion-exchanged by the ion exchange unit 31 is applied to the activation unit 12 and the preliminary alkaline solution ion-exchanged by the ion exchange unit 31 is applied to the dissolution unit 22.

The carbonization heat treatment conditions of the first heat treatment unit 11 can be the same as the carbonization heat treatment conditions of step (a-1).

The activator treatment conditions of the activation unit 12 can be the same as the activator treatment conditions of step (a-2).

The washing and drying conditions of the washing unit 13 can be the same as the washing and drying conditions of step (a-3).

The first heat treatment unit 11 can be connected to the washing unit 13 through a separate flow path, heat transfer means, or the like. For example, the waste heat of the first heat treatment unit 11 can be transferred to the washing unit 13 using gas as a medium and the waste heat of the first heat treatment unit 11 can be transferred to the washing unit 13, thereby contributing to the drying of the washing unit 13.

The first heat treatment unit 11, the activation unit 12, and the washing unit 13 can be sequentially connected through a path, and each path can include an opening and closing means, and the subject to be treated and the result of treatment can be transferred.

The second heat treatment unit 21, the dissolution unit 22, and the separation unit 23 can be sequentially connected through a path, and each path can include an opening and closing means, and the subject to be treated and the result of treatment can be transferred.

The ion exchange unit 31 can receive a preliminary alkaline solution from a separate supply unit 30.

The ion exchange unit 31 can include an ion exchange membrane containing an ion exchange resin and the ion exchange resin can be the same as described above.

The ion exchange unit 31 can include a path connected to each of the washing unit 13, the activation unit 12, the dissolution unit 22, and the supply unit 30, and each path can include a separate opening and closing means.

When waste liquid is supplied to the ion exchange unit 31 from the washing unit 13, the material can be moved in the order of the washing unit 13—the ion exchange unit 31—the activation unit 12, and other paths can be closed. The anions of the waste liquid can be exchanged with the anions of the ion exchange unit 31 through this material movement path.

Then, when the preliminary alkaline solution is supplied from the supply unit 30 to the ion exchange unit 31, the material can move in the order of the supply unit 30—ion exchange unit 31—dissolution unit 22, and other paths can be closed. Through this material movement path, the anions of the ion exchange unit 31 that has been substituted with the anions of the preliminary alkaline solution can be substituted again, so that the ion exchange resin can be regenerated.

The device 100 for producing activated carbon and silica, and for recycling resources includes can further include a concentration unit 32 connected between the ion exchange unit 31 and the dissolution unit 22. The concentration unit 32 can include an evaporation means (heating means) configured to evaporate and concentrate the second’ alkaline solution formed by substitution with the ion exchange unit 31 and can increase the concentration of the second’ alkaline solution.

In addition, the device 100 for producing activated carbon and silica, and for recycling resources can include a third heat treatment unit 24 configured to wash, dry and heat-treat the secondary residue separated by the separation unit 23. The heat treatment conditions of the third heat treatment unit 24 can be the same as the heat treatment conditions of step (b-3).

The third heat treatment unit 24 can be connected to the concentration unit 32 through a flow path and can receive steam and waste heat from the concentration unit 32.

Hereinafter, the present disclosure will be described in detail with reference to the following examples and comparative examples. However, the following examples and comparative examples should not be construed as limiting or restricting technical idea of the present disclosure.

### Example 1

(a-1) Coffee grounds were prepared as a carbon precursor and carbonization heat-treated at 500° C. in a nitrogen atmosphere for 1 hour.

(a-2) The carbonization heat-treated result was mixed with a potassium hydroxide (KOH) powder at a weight ratio of 1:3 and activated in the presence of a predetermined amount of carbon dioxide in a nitrogen atmosphere at 850° C. for 3 hours.

(a-3) The activated result was washed and then the waste liquid was washed with water such that the concentration of potassium carbonate (K₂CO₃) was set to 30 wt % and dried to obtain activated carbon.

(b-1) Rice husk was prepared as a silica-containing biomass-derived raw material and was then carbonization heat-treated in a nitrogen atmosphere at 600° C. for 0.5 hours.

(b-2) The carbonization heat-treated result was treated with a 25 wt % sodium carbonate (Na₂CO₃) solution for 1 hour and a residue was separated to obtain a filtrate. At this time, the temperature was maintained at 70° C. due to the waste heat of step (b-1).

(b-3) The filtrate was neutralized with a 20 wt % sulfuric acid (H₂SO₄) solution, and solid-liquid separation was performed to obtain a secondary residue, the secondary residue was dried, washed, and then was heat-treated in a nitrogen atmosphere at a temperature of 550° C. for 0.5 hours to obtain high-purity silica.

(c-1-1) At this time, the bicarbonate ions (HCO₃) derived from the carbonate ions of the waste liquid after the washing were substituted with the hydroxide ions (OH⁻) of the ion exchange resin through a modified polystyrene ion exchange resin containing an ammonium cation (—NR₃⁺) and a hydroxide ion (OH⁻) at the end of the ring structure.

(c-1-2) Then, a 5 wt % sodium hydroxide (NaOH) solution was added to the ion exchange resin containing the substituted bicarbonate ions (HCO₃) to substitute the bicarbonate ions with hydroxide ions, and a second’ alkaline solution containing bicarbonate ions, carbonate ions, and residual hydroxide ions was obtained. Then, the second’ alkaline solution was concentrated to a sodium carbonate concentration of 25 wt %.

(c-2) The waste liquid of step (c-1-1) was applied as an activator of step (a-2) and the concentrated second’ alkaline solution of step (c-1-2) was applied as a sodium carbonate solution of step (b-2).

### Example 2

The process was performed under the same conditions except that the waste liquid was washed with water such that the concentration of potassium carbonate (K₂CO₃) in the waste liquid after washing was set to 20 wt % in the washing step (a-3) of Example 1.

### Example 3

The process was performed under the same conditions except that the waste liquid was washed with water such that the concentration of potassium carbonate (K₂CO₃) in the waste liquid after washing was set to 10 wt % in the washing step (a-3) of Example 1.

### Comparative Example 1

The process was performed under the same conditions except that the concentration of sodium hydroxide in the preliminary alkaline solution was set to 10 wt % in the washing step (c-1-1) of Example 1.

### Comparative Example 2

The process was performed under the same conditions except that the concentration of sodium hydroxide in the preliminary alkaline solution was set to 20 wt % in the washing step (c-1-1) of Example 1.

### Comparative Example 3

The process was performed under the same conditions except that the concentration of sodium hydroxide in the preliminary alkaline solution was set to 30 wt % in the washing step (c-1-1) of Example 1.

### Experimental Example 1—Analysis of Silica Purity Depending on Type of 10 Second Alkaline Solution

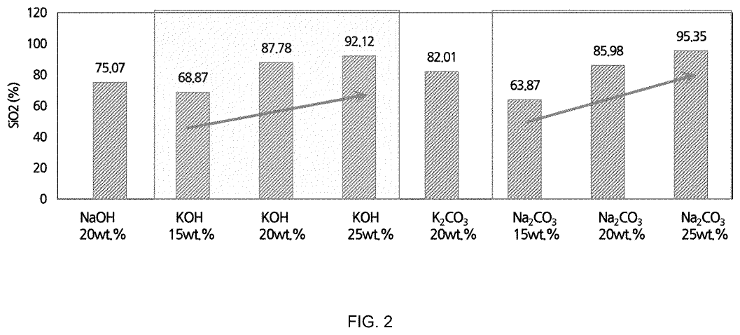

In Example 1, the alkali metal salt component and concentration of the second alkaline solution were changed to obtain silica and the resulting silica component and purity are shown in Table 1 and FIG. 2.

TABLE 1

| Item | SiO₂ | K₂O | Na₂O | SO₃ | Others* |
|---|---|---|---|---|---|
| NaOH 20 wt % | 75.07 | 0.08 | 9.32 | 12.11 | 3.42 |
| KOH 15 wt % | 68.87 | 18.03 | 0.14 | 12.88 | 0.08 |
| KOH 20 wt % | 87.78 | 7.06 | 0.06 | 4.95 | 0.15 |
| KOH 25 wt % | 92.12 | 7.55 | 0.00 | 10.05 | 0.28 |
| K₂CO₃ 20 wt % | 82.01 | 12.99 | 0.00 | 4.49 | 0.51 |
| Na₂CO₃ 15 wt % | 63.87 | 0.19 | 17.28 | 18.55 | 0.11 |
| Na₂CO₃ 20 wt % | 85.98 | 0.09 | 7.25 | 6.08 | 0.60 |
| Na₂CO₃ 25 wt % | 95.35 | 0.05 | 2.87 | 1.59 | 0.14 |

Unit: wt %,
Others*: containing CaO, P₂O₅, MnO, MgO, Fe₂O₃, Al₂O₃, NiO, ZnO

As can be seen from Table 1, the silica purity increases as the concentration of the second alkaline solution increases and high-purity silica is easily recovered along with resource recycling.

### Experimental Example 2—Analysis of Ion Exchange Rate Depending on Concentration of Waste Liquid after Washing

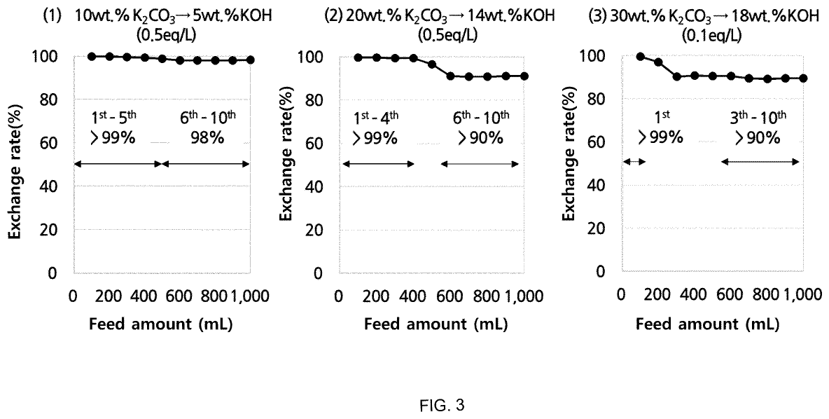

In Examples 1 to 3, the amount of washing solution injected once during the ion exchange of step (c-1-1) was set to predetermined milliliters (mL), the exchange efficiency upon the repeated ion exchange ((c-1-1) and (c-1-2)) was measured, and the results are shown in FIG. 3.

It can be seen from this that all examples had excellent ion exchange rates during about 10 ion exchanges and an alkaline solution with an appropriate concentration for activation could be obtained.

### Experimental Example 3—Analysis of Ion Exchange Rate Depending on Concentration of Preliminary Alkaline Solution

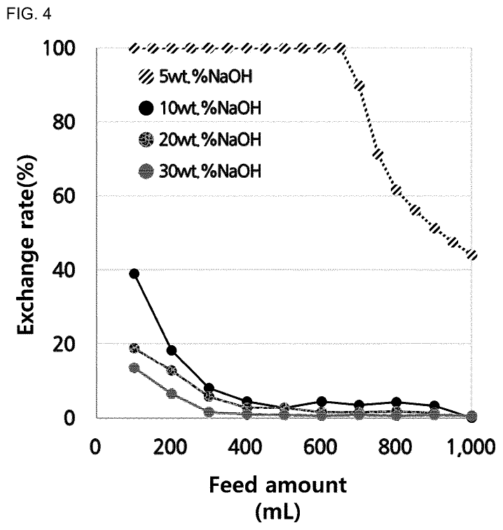

In Example 1 and Comparative Examples 1 to 3, the amount of preliminary alkaline solution injected once during the ion exchange in step (c-1-2) was set to predetermined milliliters (mL), the exchange efficiency depending on repeated ion exchange ((c-1-1) and (c-1-2)) was measured, and the results are shown in FIG. 4.

It can be seen from FIG. 4 that Example 1 had an excellent ion exchange rate during several dozen ion exchanges, and a sodium carbonate solution with a concentration of about 6.5 wt % could be obtained. In Comparative Examples 1 to 3, the initial ion exchange rate was good, but the ion exchange efficiency decreased.

According to the present disclosure, the material produced as waste liquid during production of activated carbon can contribute to formation of materials for production of silica from biomass-derived materials, thereby increasing resource recyclability.

In addition, according to the present disclosure, high-quality activated carbon and silica can be produced from organic waste and biomass-derived raw materials.

The effects of the present disclosure are not limited to those mentioned above. It should be understood that the effects of the present disclosure include all effects that can be inferred from the description of the present disclosure.

The present disclosure has been described in detail with reference to implementations thereof. However, it will be appreciated by those skilled in the art that changes can be made in these examples without departing from the principles and spirit of the present disclosure, the scope of which is defined in the appended claims and their equivalents. Therefore, it should be construed that the aforementioned implementations are illustrative and not restrictive in all respects.

What is claimed is:

1. A method for producing activated carbon and silica and recycling resources, the method comprising:
producing the activated carbon, wherein producing the activated carbon comprises:
performing a first carbonization heat-treatment on a carbon precursor,
treating the heat-treated carbon precursor with an activating agent that comprises a first alkali metal salt to produce a first mixture, and
washing and drying the first mixture to obtain the activated carbon and waste liquid; and
producing the silica, wherein producing the silica comprises:
performing a second carbonization heat-treatment on a biomass-derived raw material that comprises the silica,
treating the heat-treated biomass-derived raw material with a second alkaline solution to produce a second mixture and separating residues from the second mixture to obtain a filtrate, and
neutralizing the filtrate and performing a solid-liquid separation on the neutralized filtrate to thereby obtain the silica;
performing an ion-exchange between at least a portion of the waste liquid obtained from washing of the first mixture and preliminary alkaline solution through an ion exchange resin; and
using the ion-exchanged waste liquid toward the activating agent in producing the first mixture and using the ion-exchanged preliminary alkaline solution toward the second alkaline solution in producing the second mixture.

2. The method of claim 1, wherein the carbon precursor comprises an organic waste resource, and
wherein the organic waste resource comprises at least one of an agricultural by-product, a wood by-product, a waste paper, natural fiber waste, or a combination thereof.

3. The method of claim 1, wherein the activating agent comprises carbon dioxide, and
wherein the first alkali metal salt comprises a first alkali metal hydroxide.

4. The method of claim 3, wherein the waste liquid comprises a first alkali metal ion and a carbonate ion.

5. The method of claim 1, further comprising:
recovering waste heat that is produced from performing the first carbonization heat-treatment on the carbon precursor,
wherein washing and drying the first mixture to obtain the activated carbon and the waste liquid comprises drying the first mixture based on the waste heat.

6. The method of claim 1, wherein the biomass-derived raw material comprises the silica in an amount greater than or equal to 10 wt % and less than or equal to 20 wt %.

7. The method of claim 1, wherein the second alkaline solution comprises second alkali metal hydroxide, second alkali metal carbonate, or a combination thereof.

8. The method of claim 1, wherein a concentration of the second alkaline solution is greater than or equal to 10 wt % and less than or equal to 30 wt %.

9. The method of claim 1, wherein performing the second carbonization heat-treatment on the biomass-derived raw material produces residual heat or waste heat, and
wherein treating the heat-treated biomass-derived raw material with the second alkaline solution and separating the residues from the second mixture comprises using the residual heat or the waste heat.

10. The method of claim 1, wherein neutralizing the filtrate comprises:
using acid solution selected from a group consisting of sulfuric acid, hydrochloric acid, nitric acid, acetic acid, perchloric acid, oxalic acid, and a combination thereof.

11. The method of claim 4, wherein the ion exchange resin comprises a cation group and a hydroxide ion that is bonded to the cation group, and
wherein performing the ion-exchange between at least the portion of the waste liquid and the preliminary alkaline solution comprises:
substituting bicarbonate ions derived from carbonate ions of the waste liquid with hydroxide ions of the ion exchange resin, and
adding preliminary alkali metal hydroxide solution to the ion exchange resin that comprises the substituted bicarbonate ions to thereby substitute the bicarbonate ions with the hydroxide ions and regenerate the second alkaline solution that comprises the bicarbonate ions and residual hydroxide ions.

12. An ion exchange method during production of activated carbon and silica, the method comprising:
preparing the activated carbon by at least washing a carbon-based material that has been treated with an activating agent that comprises a first alkali metal salt;
preparing the silica by at least treating a biomass-derived material that has been subject to a first carbonization heat-treatment and that comprises the silica with a second alkaline solution;
performing an ion-exchange between (i) at least a portion of a waste liquid obtained from the washing of the carbon-based material and (ii) preliminary alkaline solution through an ion exchange resin; and
using the ion-exchanged materials toward the activating agent or toward the second alkaline solution.

13. The method of claim 12, wherein the carbon-based material comprises an organic waste resource, and
wherein the organic waste resource comprises at least one of an agricultural by-product, a wood by-product, a waste paper, natural fiber waste, or a combination thereof.

14. The method of claim 12, wherein the activating agent comprises carbon dioxide, and
wherein the first alkali metal salt comprises a first alkali metal hydroxide.

15. The method of claim 12, wherein the waste liquid comprises a first alkali metal ion and a carbonate ion.

16. The method of claim 12, wherein the biomass-derived material comprises the silica in an amount greater than or equal to 10 wt % and less than or equal to 20 wt %.

17. The method of claim 12, wherein a concentration of the second alkaline solution is greater than or equal to 10 wt % and less than or equal to 30 wt %.

18. The method of claim 12, further comprising:
performing a second carbonization heat-treatment on the carbon-based material prior to preparing the activated carbon; and
recovering waste heat that is produced from performing the second carbonization heat-treatment on the carbon-based material,
wherein preparing the activated carbon further comprises, drying, based on the waste heat, the carbon-based material that has been treated with the activating agent.

19. The method of claim 12, further comprising:
performing the first carbonization heat-treatment on the biomass-derived material prior to preparing the silica,
wherein performing the first carbonization heat-treatment on the biomass-derived material produces residual heat or waste heat, and
wherein preparing the silica by at least treating the biomass-derived material with the second alkaline solution comprises using the residual heat or the waste heat.

20. A device for producing activated carbon and silica and recycling resources, the device comprising:
an activated carbon producer, the activated carbon producer comprising:
a first heat treatment unit configured to perform first heat-treatment on a carbon precursor,
an activation unit configured to mix the heat-treated carbon precursor with an activating agent that comprises a first alkali metal salt to produce a first mixture, and
a washing unit configured to wash and dry the first mixture to obtain the activated carbon and waste liquid;
a silica producer, the silica producer comprising:
a second heat treatment unit configured to perform second heat-treatment on a biomass-derived raw material that comprises the silica,
a dissolution unit configured to (i) mix the heat-treated biomass-derived raw material with alkaline solution to produce a second mixture and (ii) obtain a residue-separated filtrate from the second mixture, and
a separation unit configured to neutralize the filtrate and perform solid-solution separation; and
an ion exchanger configured to perform an ion-exchange between at least a portion of the waste liquid obtained from washing of the first mixture and preliminary alkaline solution,
wherein the activation unit uses the ion-exchanged waste liquid and the dissolution unit uses the ion-exchanged preliminary alkaline solution.
